(19) United States
(12) Patent Application Publication
(10) Pub. No.: US 2010/0314379 A1
(43) Pub. Date: Dec. 16, 2010

(54) TEMPERATURE CONTROL DEVICE FOR VEHICLE THERMAL CUP

(76) Inventor: Hsi-Mei LIN, Tucheng City (TW)

Correspondence Address: Muncy, Geissler, Olds & Lowe, PLLC, 4000 Legato Road, Suite 310, FAIRFAX, VA, 22033, US

(21) Appl. No.: 12/482,161

(22) Filed: Jun. 10, 2009

(51) Int. Cl. H05B 1/00

(52) U.S. Cl. 219/442

(57) ABSTRACT

The present invention relates to a temperature control device for vehicle thermal cup, which is mainly assembled from a cup body, a heat conductor, a thermal insulated outer casing and a switching switch, wherein the heat conductor attached to the circumferential wall of the cup body enables liquid to be quickly heated. The switching switch installed on the surface of the thermal insulated outer casing forms an electrical circuit with a high temperature control device and a low temperature control device. Accordingly, the user can use the switching switch to select a heating or heat preservation mode to maintain the temperature of the liquid and quickly achieve the effectiveness to boil the liquid.

### BACKGROUND OF THE INVENTION

(a) Field of the Invention

The present invention provides a vehicle thermal cup, and more particularly provides a temperature control device for vehicle thermal cup that is able to effectively control the temperature of a liquid in a cup body.

(b) Description of the Prior Art

General commercial thermal cups are superimposed with heat insulating material to achieve a heat preservation effect. Referring to FIG. 1, which shows a thermal cup of the prior art, wherein a thermal cup 1 is primarily assembled from an inner casing 10 and an outer casing 12, wherein the inner casing 10 is defined with a holding space 102 used for filling with a liquid. A gap 14 is formed between the inner casing 10 and the outer casing 12, and the gap 14 is filled with heat insulating material 16 (such as: foam material, sponge). The heat preservation effect of the heat insulating material 16 is used to enable a liquid in the thermal cup 1 to maintain its original temperature. However, the thermal cup 1 only using the heat insulating material 16 to achieve the heat preservation effect is only provided with the effectiveness to preserve heat for a short time, and is unable preserve heat for long periods of time. Moreover, heating of a liquid in the thermal cup 1 cannot be carried out. Hence, for drivers who must drive for long distances, the thermal cup 1 is unable to provide the effectiveness to maintain a liquid at a suitable temperature.

### SUMMARY OF THE INVENTION

A primary objective of the present invention lies in: A temperature control device for vehicle thermal cup, which is primarily assembled from a cup body, a heat conductor, a thermal insulated outer casing and a switching switch, wherein the heat conductor is attached to the circumferential wall of the cup body. The switching switch installed on the surface of the thermal insulated outer casing is used to enable forming an electrical circuit with the heat conductor. Accordingly, the user can use the switching switch to select a heating or heat preservation mode to effect current transmission to the heat conductor and cause it to emit heat, thereby maintaining the temperature of the liquid in the cup body, or quickly achieving the effectiveness to boil the liquid.

Another objective of the present invention lies in: A cover further installed on thermal insulated outer casing, an air vent formed in the surface of the cover, and a heat sensor strip fitted to the air vent. The expansion-contraction principle of the heat sensor strip is used to enable steam from the liquid in the cup body when boiling to cause the heat sensor strip to expand from the heat and warp, thereby causing the heat sensor strip to separate from the air vent, at which time, the steam is discharged from the air vent. When the temperature of the heat sensor strip drops to a predetermined temperature value, then the heat sensor strip contracts because of the temperature drop, thereby causing the heat sensor strip to return to its original position and block off the air vent to prevent the continuous release of steam, thus maintaining the temperature of the liquid in the cup body.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a thermal cup of the prior art.

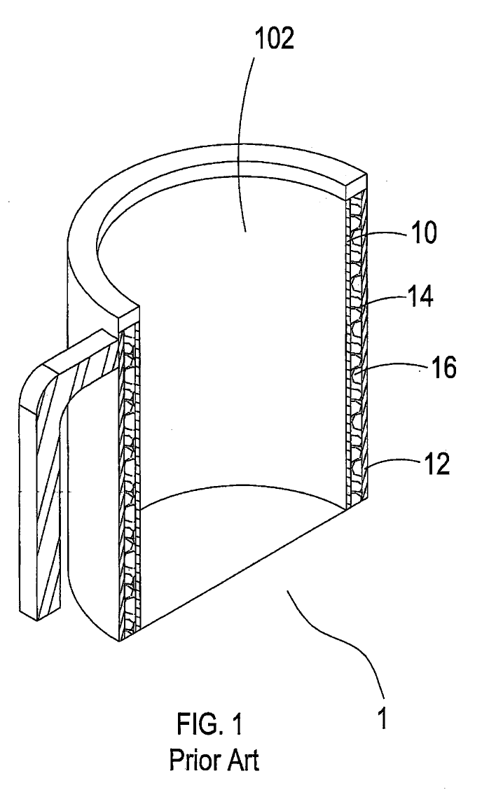

FIG. 2 is an elevational schematic view of a preferred embodiment of the present invention.

FIG. 3 is an exploded elevational schematic view of the preferred embodiment of the present invention.

FIG. 4 is a sectional schematic view of the preferred embodiment of the present invention.

FIG. 5 is a schematic view depicting an operating state of the present invention using a vehicle cigarette lighter socket power source to implement heating.

FIG. 6 is a schematic view depicting an operating state of another preferred embodiment using a vehicle cigarette lighter socket power source to implement heat preservation according to the present invention.

FIG. 7 is a schematic view depicting an operating state of yet another preferred embodiment of the thermal cup using a cup stand serving as a temperature control device according to the present invention.

### DETAILED DESCRIPTION OF THE PREFERRED EMBODIMENTS

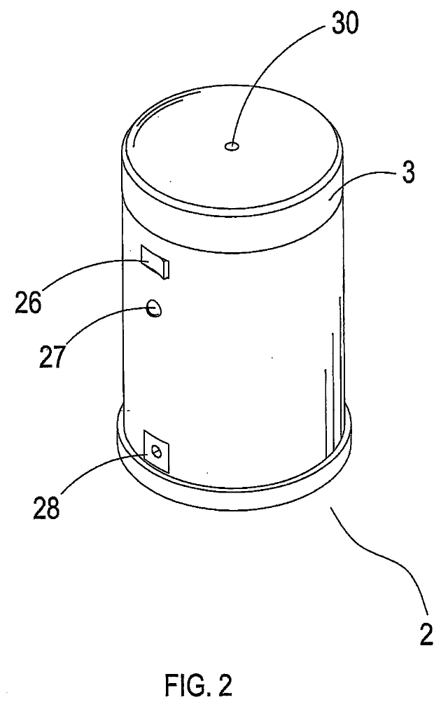

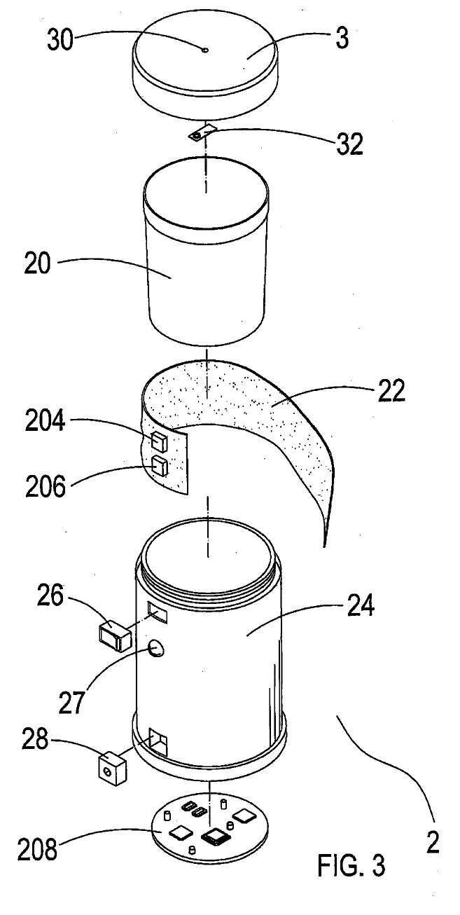

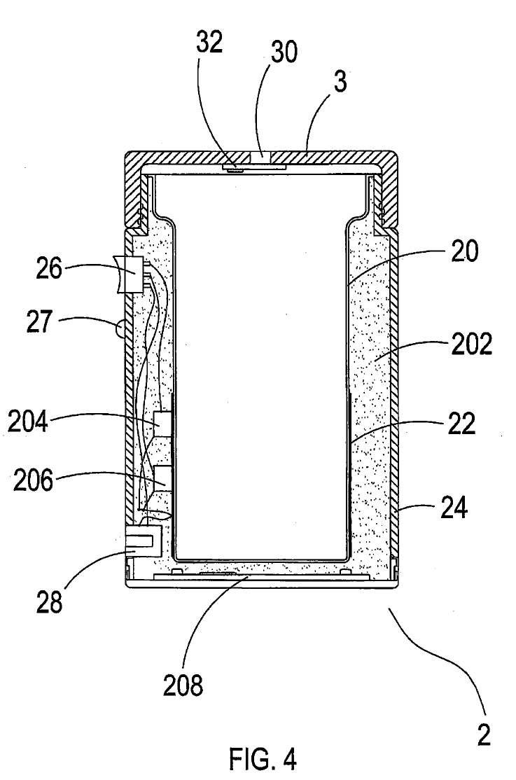

Referring to FIG. 2, FIG. 3 and FIG. 4, which show an elevational schematic view, an exploded elevational schematic view and a sectional schematic view of a preferred embodiment of the present invention, and it can be clearly seen from the drawings that a thermal cup 2 depicted in a temperature control device for vehicle thermal cup of the present invention is primarily assembled from a cup body 20, a heat conductor 22, a thermal insulated outer casing 24 and a switching switch 26, wherein the heat conductor 22 fabricated from flexible material facilitates attachment to the circumferential wall of the cup body 20, thereby enabling fast heating of a liquid in the cup body 20 to a predetermined temperature. Moreover, a sealed space 202 is formed between the thermal insulated outer casing 24 and the cup body 20. A switching switch 26 mounted on the surface of the thermal insulated outer casing 24 is used to enable forming an electrical circuit with a high temperature control device 204 and a low temperature control device 206 located within the sealed space 202. A circuit board 208 mounted within the sealed space 202 establishes an electrical connection with a power source device 28 mounted on the surface of the thermal insulated outer casing 24 to enable supplying electric energy and controlling the voltage range. Indicator lights 27 are additionally located on the surface of the thermal insulated outer casing 24, and display of the indicator lights 27 is used to know the operating situation. Accordingly, the user can use the switching switch 26 to select a heating or heat preservation mode to effect current transmission to the heat conductor 22 and cause it to emit heat, thereby maintaining the temperature of the liquid in the cup body 20, or quickly achieving the effectiveness to boil the liquid.

Furthermore, a cover 3 is installed on the thermal insulated outer casing 24, an air vent 30 is formed in the surface of the cover 3, and the air vent 30 is fitted with a heat sensor strip 32. The expansion-contraction principle of the heat sensor strip 32 is used to enable steam from the liquid in the cup body 20 when boiling to cause the heat sensor strip 32 to expand from the heat and warp, thereby causing the heat sensor strip 32 to separate from the air vent 30, at which time, the steam is discharged from the air vent 30.

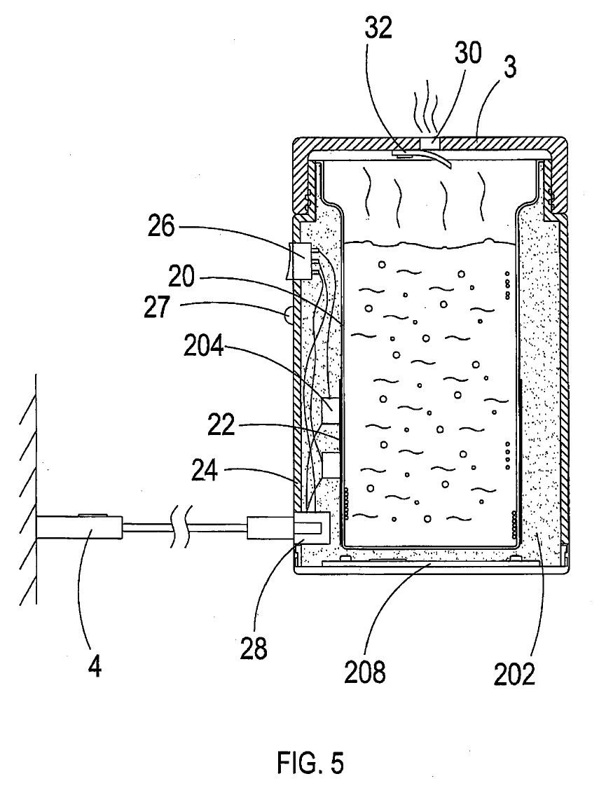

Referring together with FIG. 5, which shows a schematic view depicting an operating state of the present invention using a vehicle cigarette lighter socket power source to implement heating, and it can be clearly seen from the drawing that the power source device 28 is connected to a vehicle cigarette lighter socket power source 4, and the circuit board 208 is used to provide a fixed voltage (such as: 12V or 24V), so that when the user wants to heat a liquid, then the switching switch 26 installed on the surface of the thermal insulated outer casing 24 is used to enable an electrical circuit to be formed with the high temperature control device 204 attached to the outer wall of the cup body 20 and positioned within the sealed space 202 (using adiabatic material as an example), and the high temperature control device 204 forms an electrical connection with the heat conductor 22. Accordingly, a liquid in the cup body 20 can be heated. In addition, when the liquid in the cup body 20 reaches a high temperature range preset by the high temperature control device 204, then the high temperature control device 204 transmits an electrical signal to the switching switch 26 to cut off the power supply and maintain the temperature, and the operating situation can be known from a display of the indicator lights 27.

Furthermore, the air vent 30 is formed in the surface of the cover 3 installed on the thermal insulated outer casing 24, and the air vent 30 is fitted with the heat sensor strip 32. The expansion-contraction principle of the heat sensor strip 32 is used to enable steam from the liquid in the cup body 20 when boiling to cause the heat sensor strip 32 to expand from the heat and warp, thereby causing the heat sensor strip 32 to separate from the air vent 30, at which time, the steam is discharged from the air vent 30.

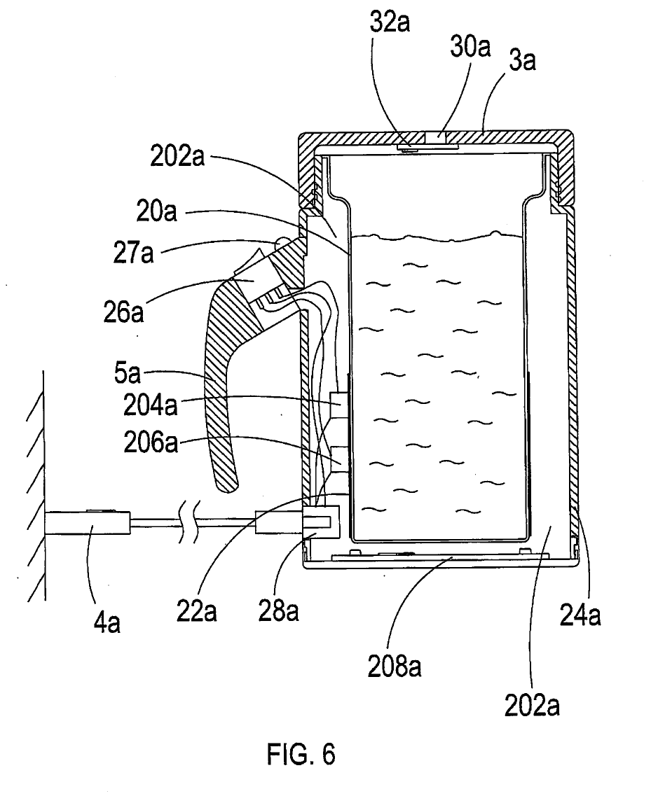

Referring to FIG. 6, which shows a schematic view depicting an operating state of another preferred embodiment using a vehicle cigarette lighter socket power source to implement heat preservation according to the present invention, and it can be clearly seen from the drawing that a circuit board 208a mounted within a sealed space 202a is electrically connected to a power source device 28a located on the surface of a thermal insulated outer casing 24a, and the power source device 28a is connected to a vehicle cigarette lighter socket power source 4a, the circuit board 208a being used to provide a fixed voltage (such as: 12V or 24V). Using a handle 5a installed to the thermal insulated outer casing 24a as an illustrative embodiment, when the user wants to maintain the heat of a liquid in a cup body 20a, a switching switch 26a and indicator lights 27a are installed at predetermined positions on the handle 5a, and the switching switch 26a is used to enable forming an electrical circuit with a low temperature control device 206a attached to the outer wall of the cup body 20a and positioned within the sealed space 202a (using a vacuum state as an example), and to form an electrical connection with a heat conductor 22a. Accordingly, the temperature state of the liquid in the cup body 20a can be maintained. In addition, when the temperature of the liquid in the cup body 20a drops to a low temperature range preset by the low temperature control device 206a, then the low temperature control device 206a transmits an electrical signal to the switching switch 26a to activate a high temperature control device 204a to implement heating of the liquid in the cup body 20a. Furthermore, a connection between the indicator lights 27a and the switching switch 26a is used to know the heating state of the thermal cup 2a.

A cover 3a is installed atop the thermal insulated outer casing 24a, an air vent 30a is formed in the surface of the cover 3a, and the air vent 30a is fitted with a heat sensor strip 32a. The expansion-contraction principle of the heat sensor strip 32a is used, whereby, when the temperature of the heat sensor strip 32a drops to a predetermined temperature value, then the heat sensor strip 32a contracts because of the temperature drop, thereby causing the heat sensor strip 32a to return to its original position and block off the air vent 30a to prevent the continuous release of steam, thus maintaining the temperature of the liquid in the cup body 20a.

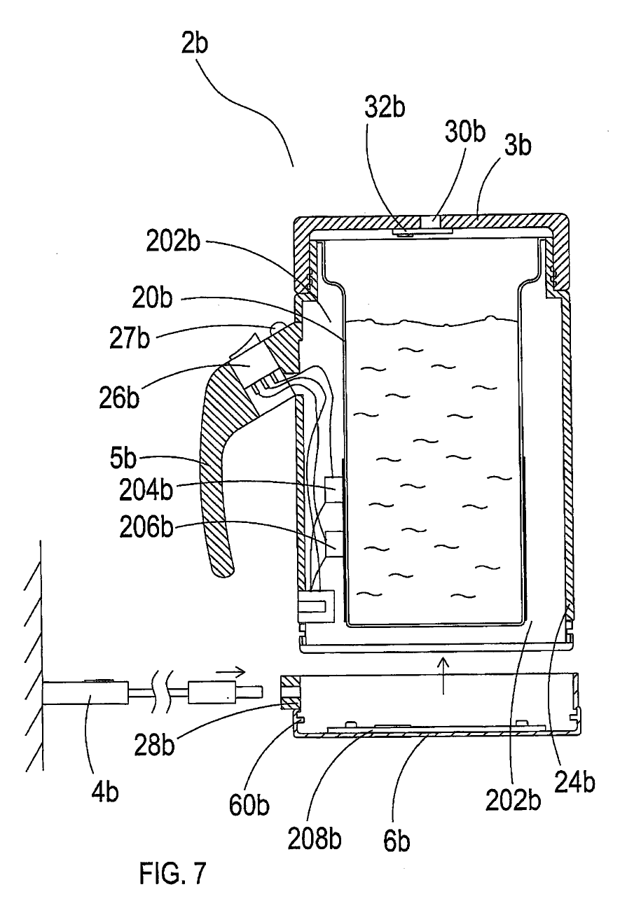

Referring to FIG. 7, which shows a schematic view depicting an operating state of yet another preferred embodiment of the thermal cup using a cup stand serving as a temperature control device according to the present invention, and it can be clearly seen from the drawing that a power source device 28b and a circuit board 208b are respectively installed in a cup stand 6b fixed to the inside of a vehicle, and the power source device 28b and the circuit board 208b are mutually electrically connected. Electric conducting fixing members 60b are disposed within the cup stand 6b, and the electric conducting fixing members 60b are not only able to conduct electricity to a cup body 20b, but also fixedly secure the cup stand 6b to prevent toppling over thereof. Moreover, the power source device 28b is connected to a power source 4b of a vehicle cigarette lighter socket, and the circuit board 208b is used to provide a fixed voltage (such as: 12V or 24V). Using a handle 5b installed to a thermal insulated outer casing 24b as an illustrative embodiment, when the user wants to maintain the heat of a liquid in the cup body 20b, a switching switch 26b and indicator lights 27b are installed at predetermined positions on the handle 5b, and the switching switch 26b is used to enable forming an electrical circuit with a low temperature control device 206b attached to the outer wall of a cup body 20b and positioned within a sealed space 202b (using a vacuum state as an example), and to form an electrical connection with a heat conductor 22b. Accordingly, the temperature state of the liquid in the cup body 20b can be maintained. In addition, when the temperature of the liquid in the cup body 20b drops to a low temperature range preset by a low temperature control device 206b, then the low temperature control device 206b transmits an electrical signal to the power source device 28b to activate a high temperature control device 204b to implement heating of the liquid in the cup body 20b. Furthermore, a connection between the indicator lights 27b and the switching switch 26b is used to know the heating state of the thermal cup 2b.

A cover 3b is installed atop the thermal insulated outer casing 24b, an air vent 30b is formed in the surface of the cover 3b, and the air vent 30b is fitted with a heat sensor strip 32b. The expansion-contraction principle of the heat sensor strip 32b is used, whereby, when the temperature of the heat sensor strip 32b drops to a predetermined temperature value, then the heat sensor strip 32b contracts because of the temperature drop, thereby causing the heat sensor strip 32b to return to its original position and block off the air vent 30b to prevent the continuous release of steam, thus maintaining the temperature of the liquid in the cup body 20b.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A temperature control device for vehicle thermal cup, comprising:
a cup body, the cup body is defined with a filling space for filling with a liquid;
a heat conductor, the heat conductor is attached to the circumferential wall of the cup body, and enables fast heating of liquid in the cup body to a predetermined temperature;
a thermal insulated outer casing, a sealed space is formed between the thermal insulated outer casing and the cup body; and
a switching switch, the switching switch is mounted on the surface of the thermal insulated outer casing, and the switching switch enables forming an electrical circuit with the heat conductor.

2. The temperature control device for vehicle thermal cup according to claim 1, wherein a high temperature control device and a low temperature control device are installed within the sealed space, and the high temperature control device and the low temperature control device form an electrical circuit with the switching switch and the heat conductor.

3. The temperature control device for vehicle thermal cup according to claim 1, wherein the switching switch comprises a heat preservation switch, a power failure switch and a heating switch, which are used to respectively control the heating temperature of the heat conductor.

4. The temperature control device for vehicle thermal cup according to claim 2, wherein the switching switch comprises a heat preservation switch, a power failure switch and a heating switch, which are used to respectively control the heating temperature of the heat conductor.

5. The temperature control device for vehicle thermal cup according to claim 1, wherein the heat conductor is a flexible material.

6. The temperature control device for vehicle thermal cup according to claim 2, wherein the heat conductor is a flexible material.

7. The temperature control device for vehicle thermal cup according to claim 1, wherein a circuit board is mounted within the sealed space, the circuit board and a power source device installed to the thermal insulated outer casing are mutually electrically connected to enable controlling the voltage range.

8. The temperature control device for vehicle thermal cup according to claim 1, further comprising a cover able to be fixedly locked to the thermal insulated outer casing, an air vent is formed in the surface of the cover, and the air vent is fitted with a heat sensor strip.

9. The temperature control device for vehicle thermal cup according to claim 1, wherein the sealed space is filled with either adiabatic material or is in a vacuum state.

10. The temperature control device for vehicle thermal cup according to claim 1, wherein the thermal insulated outer casing is further fitted with a handle, and the switching switch and at least one indicator light are installed at predetermined positions on the handle.
